(19) United States
(12) Patent Application Publication
(10) Pub. No.: US 2019/0066406 A1
(43) Pub. Date: Feb. 28, 2019

(54) METHOD AND APPARATUS FOR MONITORING A VEHICLE

(71) Applicant: GM Global Technology Operations LLC., Detroit, MI (US)

(72) Inventors: Azeem Sarwar, Rochester Hills, MI (US); Steven W. Holland, St. Clair, MI (US); Paul E. Krajewski, Troy, MI (US)

(73) Assignee: GM Global Technology Operations LLC,, Detroit, MI (US)

(21) Appl. No.: 15/688,440

(22) Filed: Aug. 28, 2017

(51) Int. Cl. G07C 5/08

(52) U.S. Cl. CPC G07C 5/085; G07C 5/0808

(57) ABSTRACT

A vehicle control system includes a plurality of components that are disposed to effect a vehicle function and a controller in communication with the plurality of components. A method for controlling the vehicle includes monitoring states of health (SOHs) of the plurality of components. Upon detecting a change in status of the SOH of the subject component, an allowable window of operation for the subject component and an allowable window of operation for the related component are determined, and operating constraints related to the vehicle function are determined based upon the allowable windows of operation for the subject component and the related component. Operation of the vehicle is controlled subject to the operating constraints related to the vehicle function.

### INTRODUCTION

Vehicles can include on-board monitoring systems to detect occurrence of a fault or another indication of a need for service and/or vehicle maintenance.

### SUMMARY

A vehicle control system is described, and includes a plurality of components that are disposed to effect a vehicle function, wherein the plurality of components includes a subject component and a related component. A controller is in communication with the plurality of components that are disposed to effect a vehicle function, and the controller includes a processor and a memory device including an instruction set. A method for controlling the vehicle includes monitoring states of health (SOHs) of the plurality of components. Upon detecting a change in status of the SOH of the subject component, an allowable window of operation for the subject component, and an allowable window of operation for the related component are determined, and operating constraints related to the vehicle function are determined based upon the allowable window of operation for the subject component and the allowable window of operation for the related component. Operation of the vehicle is controlled subject to the operating constraints related to the vehicle function.

An aspect of the disclosure includes determining an allowable window of operation for the subject component which includes determining a limitation to the subject component to enable completion of the trip.

Another aspect of the disclosure includes the limitation to the subject component to enable completion of the trip being an operating constraint for the subject component.

Another aspect of the disclosure includes the limitation to the subject component to enable completion of the trip being a performance constraint for the subject component associated with the vehicle function.

Another aspect of the disclosure includes determining a limitation to the related component to compensate for the limitation to the subject component.

Another aspect of the disclosure includes the limitation to the related component to enable completion of the trip being an operating constraint for the related component.

Another aspect of the disclosure includes the limitation to the related component to enable completion of the trip being a performance constraint for the related component associated with the vehicle function.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a vehicle including an autonomic vehicle control system and associated controllers, in accordance with the disclosure;

FIG. 2 schematically shows an information flow diagram for a routine for the vehicle that is described with reference to FIG. 1, wherein the routine executes to determine a working envelope of components and systems based on their respective state of health and generate an adaptable control and management scheme that facilitates component/system life and acceptable vehicle performance during a trip when prognosis of one or more of the systems or components indicates deterioration or a fault in its operation, in accordance with the disclosure;

FIG. 3-1 graphically depicts states of health (SOHs) associated with a plurality of components, subsystems or systems, in accordance with the disclosure;

FIG. 3-2 is a spider graph that indicates states of health for a plurality of vehicle components, subsystems or systems, in accordance with the disclosure;

FIG. 3-3 graphically shows a magnitude of composite vehicle SOH (%) on the vertical axis in relation to usage, wherein usage can be either time or distance, including a first composite SOH for the vehicle under a managed condition and a second composite SOH for the vehicle under an unmanaged condition, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, technical material that is understood in the related art has not been described in detail in order to avoid unnecessarily obscuring the disclosure. Furthermore, the disclosure, as illustrated and described herein, may be practiced in the absence of an element that is not specifically disclosed herein.

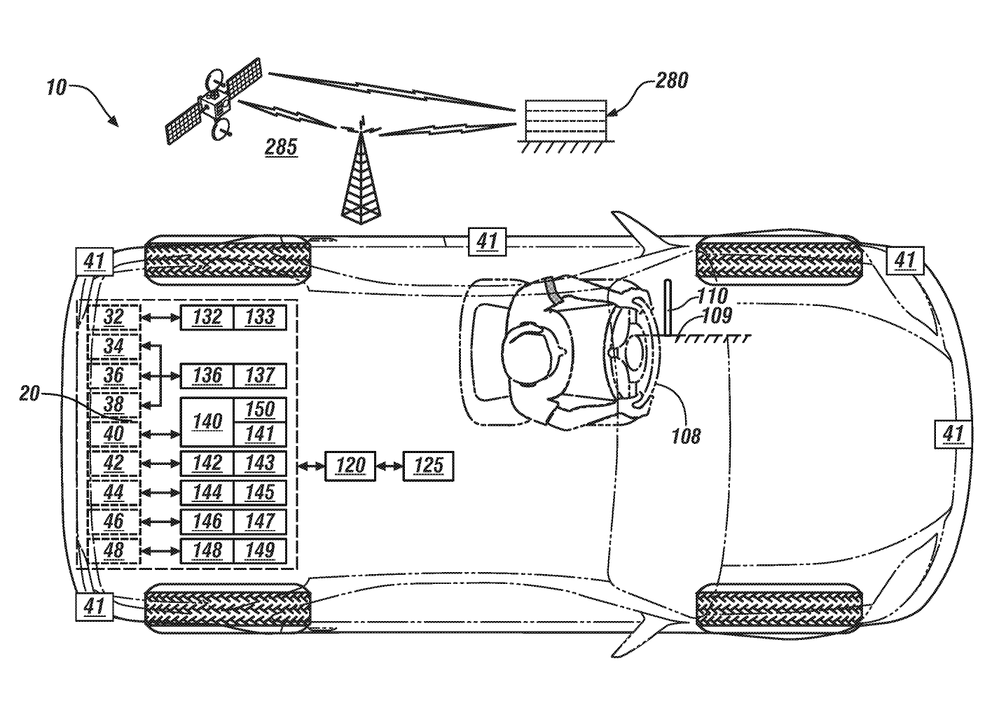

Referring to the drawings, wherein like reference numerals correspond to like or similar components throughout the several Figures, FIG. 1, consistent with embodiments disclosed herein, illustrates a vehicle 10 that includes an autonomic vehicle control system 20 and an associated vehicle health monitoring (VHM) controller 120 that is illustrative of the concepts described herein. Alternatively, the vehicle 10 may be a non-autonomous vehicle that employs an embodiment of the vehicle health monitoring (VHM) controller 120. The vehicle 10 includes, in one embodiment, a four-wheel passenger vehicle with steerable front wheels and fixed rear wheels. The vehicle 10 may include, by way of non-limiting examples, a passenger vehicle, a light-duty or heavy-duty truck, a utility vehicle, an agricultural vehicle, an industrial/warehouse vehicle, or a recreational off-road vehicle.

As employed herein, the autonomic vehicle control system 20 includes an on-vehicle control system that is capable of providing a level of driving automation. The terms ‘driver’ and ‘operator’ describe the person responsible for directing operation of the vehicle 10, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle. Driving automation can include some level of automatic control or intervention related to simultaneous control of multiple vehicle functions, such as steering, acceleration, and/or braking, with the driver continuously having overall control of the vehicle. Driving automation can include simultaneous automatic control of all vehicle driving functions, including steering, acceleration, and braking, wherein the driver cedes control of the vehicle for a period of time during a trip. Driving automation can include simultaneous automatic control of vehicle driving functions, including steering, acceleration, and braking, wherein the driver cedes control of the vehicle for an entire trip. Driving automation includes hardware and controllers configured to monitor the spatial environment under various driving modes to perform various driving tasks during dynamic operation. Driving automation can include, by way of non-limiting examples, cruise control, adaptive cruise control, lane-change warning, intervention and control, automatic parking, acceleration, braking, and the like.

The autonomic vehicle control system 20 preferably includes one or a plurality of vehicle systems and associated controllers that provide a level of driving automation, and the VHM controller 120 is disposed to monitor, prognosticate and/or diagnose operation of the autonomic vehicle control system 20. The vehicle systems, subsystems and controllers associated with the autonomic vehicle control system 20 are implemented to execute one or a plurality of operations associated with autonomous vehicle functions, including, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. The vehicle systems and associated controllers of the autonomic vehicle control system 20 can include, by way of non-limiting examples, a drivetrain 32 and drivetrain controller (PCM) 132; a steering system 34, a braking system 36 and a chassis system 38, which are controlled by a vehicle controller (VCM) 136; a vehicle spatial monitoring system 40 and spatial monitoring controller 140, a human-machine interface (HMI) system 42 and HMI controller 142; an HVAC system 44 and associated HVAC controller 144; operator controls 46 and an associated operator controller 146; and a vehicle lighting, illumination and external signaling system 48 and associated lighting controller 148.

Each of the vehicle systems and associated controllers may further include one or more subsystems and an associated controller. The subsystems and controllers are shown as discrete elements for ease of description. The foregoing classification of the subsystems is provided for purposes of describing one embodiment, and is illustrative. Other configurations may be considered within the scope of this disclosure. It should be appreciated that the functions described and performed by the discrete elements may be executed using one or more devices that may include algorithmic code, calibrations, hardware, application-specific integrated circuitry (ASIC), and/or off-board or cloud-based computing systems. Each of the aforementioned controllers includes a VHM agent, which can be implemented and executed as algorithmic code, calibrations, hardware, application-specific integrated circuitry (ASIC), or other elements. Each of the VHM agents is configured to perform component and sub-system monitoring, feature extraction, data filtering and data recording for the associated controller. The data recording can include periodic and/or event-based data recording, single time-point data recording and/or consecutive time-point data recording for certain time duration, such as before and/or after the trigger of an event. Such data recording can be accomplished employing circular memory buffers or another suitable memory device.

The PCM 132 communicates with and is operatively connected to the drivetrain 32, and executes control routines to control operation of an engine and/or other torque machines, a transmission and a driveline, none of which are shown, to transmit tractive torque to the vehicle wheels in response to driver inputs, external conditions, and vehicle operating conditions. The PCM 132 is shown as a single controller, but can include a plurality of controller devices operative to control various powertrain actuators, including the engine, transmission, torque machines, wheel motors, and other elements of the drivetrain 32, none of which are shown. By way of a non-limiting example, the drivetrain 32 can include an internal combustion engine and transmission, with an associated engine controller and transmission controller. Furthermore, the internal combustion engine may include a plurality of discrete subsystems with individual controllers, including, e.g., an electronic throttle device and controller, fuel injectors and controller, etc. The drivetrain 32 may also be composed of an electrically-powered motor/generator with an associated power inverter module and inverter controller. The control routines of the PCM 132 may also include an adaptive cruise control system (ACC) that controls vehicle speed, acceleration and braking in response to driver inputs and/or autonomous vehicle control inputs. The PCM 132 also includes a PCM VHM agent 133.

The VCM 136 communicates with and is operatively connected to a plurality of vehicle operating systems and executes control routines to control operation thereof. The vehicle operating systems can include braking, stability control, and steering, which can be controlled by actuators associated with the braking system 36, the chassis system 38 and the steering system 34, respectively, which are controlled by the VCM 136. The VCM 136 is shown as a single controller, but can include a plurality of controller devices operative to monitor systems and control various vehicle actuators. The VCM 136 also includes a VCM VHM agent 137.

The steering system 34 is configured to control vehicle lateral motion. The steering system 34 can include an electrical power steering system (EPS) coupled with an active front steering system to augment or supplant operator input through a steering wheel 108 by controlling steering angle of the steerable wheels of the vehicle 10 during execution of an autonomic maneuver such as a lane change maneuver. An exemplary active front steering system permits primary steering operation by the vehicle driver including augmenting steering wheel angle control to achieve a desired steering angle and/or vehicle yaw angle. Alternatively or in addition, the active front steering system can provide complete autonomous control of the vehicle steering function. It is appreciated that the systems described herein are applicable with modifications to vehicle steering control systems such as electrical power steering, four/rear wheel steering systems, and direct yaw control systems that control traction of each wheel to generate a yaw motion.

The braking system 36 is configured to control vehicle braking, and includes wheel brake devices, e.g., disc-brake elements, calipers, master cylinders, and a braking actuator, e.g., a pedal. Wheel speed sensors monitor individual wheel speeds, and a braking controller that can be mechanized to include anti-lock braking functionality.

The chassis system 38 preferably includes a plurality of on-board sensing systems and devices for monitoring vehicle operation to determine vehicle motion states, and, in one embodiment, a plurality of devices for dynamically controlling a vehicle suspension. The vehicle motion states preferably include, e.g., vehicle speed, steering angle of the steerable front wheels, and yaw rate. The on-board sensing systems and devices include inertial sensors, such as rate gyros and accelerometers. The chassis system 38 estimates the vehicle motion states, such as longitudinal speed, yaw-rate and lateral speed, and estimates lateral offset and heading angle of the vehicle 10. The measured yaw rate is combined with steering angle measurements to estimate the vehicle state of lateral speed. The longitudinal speed may be determined based upon signal inputs from wheel speed sensors arranged to monitor each of the front wheels and rear wheels. Signals associated with the vehicle motion states that can be communicated to and monitored by other vehicle control systems for vehicle control and operation.

The vehicle spatial monitoring system 40 and spatial monitoring controller 140 can include a controller and a plurality of spatial sensors 41, wherein each of the spatial sensors 41 is disposed on-vehicle to monitor a field of view of objects and geographic regions that are proximal to the vehicle 10. The spatial monitoring controller 140 generates digital representations of each of the fields of view including proximate remote objects based upon data inputs from the spatial sensors. The spatial monitoring controller 140 also includes a spatial monitoring VHM agent 141. The spatial monitoring controller 140 can evaluate inputs from the spatial sensors 41 to determine a linear range, relative speed, and trajectory of the vehicle 10 in view of each proximate remote object. The spatial sensors 41 can be located at various locations on the vehicle 10, including the front corners, rear corners, rear sides and mid-sides. The spatial sensors 41 can include a front radar sensor and a camera in one embodiment, although the disclosure is not so limited. Placement of the aforementioned spatial sensors 41 permits the spatial monitoring controller 140 to monitor traffic flow including proximate vehicles and other objects around the vehicle 10. Data generated by the spatial monitoring controller 140 may be employed by a lane mark detection processor (not shown) to estimate the roadway. The spatial sensors 41 of the vehicle spatial monitoring system 40 can further include object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other known camera/video image processors which utilize digital photographic methods to ‘view’ forward objects including one or more vehicle(s). Such sensing systems are employed for detecting and locating objects in automotive applications and are useable with systems including, e.g., adaptive cruise control, autonomous braking, autonomous steering and side-object detection.

The spatial sensors 41 associated with the vehicle spatial monitoring system 40 are preferably positioned within the vehicle 10 in relatively unobstructed positions to monitor the spatial environment. As employed herein, the spatial environment includes external elements, including fixed objects such as signs, poles, trees, houses, stores, bridges, etc.; and, moving or moveable objects such as pedestrians and other vehicles. Each of these spatial sensors 41 provides an estimate of actual location or condition of an object, wherein said estimate includes an estimated position and standard deviation. As such, sensory detection and measurement of object locations and conditions are typically referred to as ‘estimates.’ It is further appreciated that the characteristics of these spatial sensors 41 are complementary, in that some are more reliable in estimating certain parameters than others. The spatial sensors 41 can have different operating ranges and angular coverages capable of estimating different parameters within their operating ranges. For example, radar sensors can usually estimate range, range rate and azimuth location of an object, but are not normally robust in estimating the extent of a detected object. A camera with vision processor is more robust in estimating a shape and azimuth position of the object, but is less efficient at estimating the range and range rate of an object. Scanning type lidar sensors perform efficiently and accurately with respect to estimating range, and azimuth position, but typically cannot estimate range rate, and are therefore not as accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, some of the spatial sensors 41 present parametric variances during operation, although overlapping coverage areas of the sensors create opportunities for sensor data fusion.

The HVAC system 44 is disposed to manage the ambient environment of the passenger compartment, including, e.g., temperature, humidity, air quality and the like, in response to operator commands that are communicated to the HVAC controller 144, which controls operation thereof. The HVAC controller 144 also includes an HVAC VHM agent 145.

The operator controls 46 can be included in the passenger compartment of the vehicle 10 and may include, by way of non-limiting examples, a steering wheel 108, an accelerator pedal, a brake pedal and an operator input device 110. The operator controls 46 and associated operator controller 146 enable a vehicle operator to interact with and direct operation of the vehicle 10 in functioning to provide passenger transportation. The operator controller 146 also includes an operator controller VHM agent 147. The operator control devices including the steering wheel 108, accelerator pedal, brake pedal, transmission range selector and the like may be omitted in some embodiments of the vehicle 10.

The steering wheel 108 can be mounted on a steering column 109 with the input device 110 mechanically mounted on the steering column 109 and configured to communicate with the operator controller 146. Alternatively, the input device 110 can be mechanically mounted proximate to the steering column 109 in a location that is convenient to the vehicle operator. The input device 110, shown herein as a stalk projecting from column 109, can include an interface device by which the vehicle operator may command vehicle operation in one or more autonomic control modes, e.g., by commanding activation of element(s) of the autonomic vehicle control system 20. The mechanization of the input device 110 is illustrative. The input device 110 may be mechanized in one or more of a plurality of devices, or may be in the form of a controller that is voice-activated, or may be another suitable system. The input device 110 preferably has control features and a location that is used by present turn-signal activation systems. Alternatively, other input devices, such as levers, switches, buttons, and voice recognition input devices can be used in place of or in addition to the input device 110.

The HMI system 42 provides for human/machine interaction, for purposes of directing operation of an infotainment system, an on-board GPS tracking device, a navigation system and the like, and includes an HMI controller 142. The HMI controller 142 monitors operator requests and provides information to the operator including status of vehicle systems, service and maintenance information. The HMI controller 142 can also include a global positioning/navigation system. The HMI controller 142 communicates with and/or controls operation of a plurality of operator interface devices, wherein the operator interface devices are capable of transmitting a message associated with operation of one of the autonomic vehicle control systems. The HMI controller 142 may also communicate with one or more devices that monitor biometric data associated with the vehicle operator, including, e.g., eye gaze location, posture, and head position tracking, among others. The HMI controller 142 is depicted as a unitary device for ease of description, but may be configured as a plurality of controllers and associated sensing devices in an embodiment of the system described herein. The HMI controller 142 also includes an HMI VHM agent 143. Operator interface devices can include devices that are capable of transmitting a message urging operator action, and can include an electronic visual display module, e.g., a liquid crystal display (LCD) device, a heads-up display (HUD), an audio feedback device, a wearable device and a haptic seat. The operator interface devices that are capable of urging operator action are preferably controlled by or through the HMI controller 142. The HUD may project information that is reflected onto an interior side of a windshield of the vehicle, in the field of view of the operator, including transmitting a confidence level associated with operating one of the autonomic vehicle control systems. The HUD may also provide augmented reality information, such as lane location, vehicle path, directional and/or navigational information, and the like.

The vehicle lighting, illumination and external signaling system 48 includes a plurality of headlamps, tail lamps, brake lamps, marker lamps, signal lamps, and the like, which are controllable via the lighting controller 148. The lighting controller 148 is in communication with ambient light sensors, the GPS system, and the navigation system, and executes control routines that selectively illuminate various ones of the headlamps, tail lamps, brake lamps, marker lamps, signal lamps based upon the ambient light, the direction of intended travel from the GPS and navigation systems, and other factors. Other factors may include an override command to illuminate the vehicle lamps in a construction zone. The lighting controller 148 also includes a lighting VHM agent 149.

In one embodiment, the vehicle 10 is configured to communicate with the communication network 285, including communicating between a controller associated with an intelligent highway system and the vehicle 10. An intelligent highway system can be configured to monitor locations, speeds and trajectories of a plurality of vehicles, with such information employed to facilitate control of one or a plurality of similarly-situated vehicles. This can include communicating geographic location, forward velocity and acceleration rate of one or more vehicles in relation to the vehicle 10. In one embodiment, the vehicle 10 is configured to communicate with an off-board controller 280 via the communication network 285.

The VHM controller 120 is configured to autonomously monitor health of various on-board subsystems that perform one or more functions related to autonomous vehicle operation. The VHM controller 120 includes a controller architecture that is configured with multilayer hierarchical VHM data processing, collection, and storage employing the plurality of VHM agents that are associated with a VHM master controller that may communicate with the off-board controller 280. In one embodiment, selected elements and/or functions of the VHM controller 120 can be implemented and/or executed at the off-board controller 280. This configuration can serve to reduce data processing complexity, data collection and data storage costs. The VHM controller 120 provides a centralized system monitoring and a distributed system monitoring arrangement with data collection via the VHM master controller and the plurality of VHM agents to provide a rapid response time and an integrated vehicle/system level coverage. The VHM controller 120 can also include a fault mitigation controller and a redundant VHM master controller to verify integrity of VHM information employed by the fault mitigation controller. The VHM controller 120 can further include a maintenance event manager, an appointment log and a scheduling controller for scheduling, managing, and facilitating vehicle service and maintenance appointments.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. The term ‘model’ refers to a processor-based or processor-executable code and associated calibration that simulates a physical existence of a device or a physical process. The terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form.

Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “prognosis”, “prognostics”, and related terms are associated with data monitoring and algorithms and evaluations that render an advance indication of a likely future event associated with a component, a subsystem, or a system. Prognostics can include classifications that include a first state that indicates that the component, subsystem, or system is operating in accordance with its specification (“Green” or “G”), a second state that indicates deterioration in the operation of the component, subsystem, or system (“Yellow” or “Y”), and a third state that indicates a fault in the operation of the component, subsystem, or system (“Red” or “R”). The terms “diagnostics”, “diagnosis” and related terms are associated with data monitoring and algorithms and evaluations that render an indication of presence or absence of a specific fault with a component, subsystem or system. The term “mitigation” and related terms are associated with operations, actions or control routine that operate to lessen the effect of a fault in a component, subsystem or system.

The telematics controller 125 includes a wireless telematics communication system capable of extra-vehicle communications, including communicating with a communication network system 285 having wireless and wired communication capabilities. The telematics controller 125 is capable of extra-vehicle communications that includes short-range vehicle-to-vehicle (V2V) communication. Alternatively or in addition, the telematics controller 125 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics controller, and the handheld device executes the extra-vehicle communication, including communicating with the off-board controller 280 via the communication network 285. Alternatively or in addition, the telematics controller executes the extra-vehicle communication directly by communicating with the off-board controller 280 via a communication network 285.

Prognostic classification routines to determine a prognostic, i.e., R/Y/G, for each of the subsystems can be executed in the VHM controller 120. The prognostic classification routines can detect occurrence of a Green prognostic associated with one of the vehicle subsystems and associated controllers of the autonomic vehicle control system 20, and the VHM controller 120 can block associated data transmission off board via the communication network 285 to reduce data communication load to the off-board controller 280. Alternatively, the transmission of a Green prognostic can be in the form of a simple acknowledgement of Green determination for a component, subsystem, or system of one of the vehicle systems and associated controllers of the autonomic vehicle control system 20 with a time stamp, thus minimizing the data transmission load to the off-board controller 280.

The VHM controller 120 includes executable routines that evaluate on-vehicle devices that monitor the spatial environment proximal to the vehicle 10, including, e.g., the spatial sensors 41, the vehicle spatial monitoring system 40, spatial monitoring controller 140 and spatial monitoring VHM agent 141 that are described with reference to FIG. 1.

The spatial monitoring controller 140 includes a perception module 150 that is configured to monitor vehicle position, vehicle dynamic states and the spatial environment proximal to the vehicle 10. The perception module 150 is disposed on-vehicle to monitor and characterize the spatial environment proximal to the vehicle 10, which is provided to the vehicle systems and associated controllers of the autonomic vehicle control system 20 to provide a level of driving automation. Data and signal inputs to the perception module 150 include spatial environment data in the form of inputs from the spatial sensors 41, which include cameras, radars, lidars, etc. Data inputs to the perception module 150 further include map data in the form of a detailed 3D map of the surrounding environment and position data from the GPS. Data inputs to the perception module 150 further includes vehicle dynamic data in the form of data collected from in-vehicle sensors such as gyros and wheel speed sensors. Data inputs to the perception module 150 further includes information communicated from other vehicles, e.g., V2V data, and information communicated from the infrastructure, e.g., V2X data.

The perception module 150 includes localization, object detection, and classification algorithms to estimate the position of the current road, the current traffic lane, the types and position of objects and obstacles, including both static and dynamic obstacles and objects. The perception module 150 can estimate motion and behavior of the surrounding moving obstacles on the road and on the traffic lane. The perception module 150 also monitors and estimates vehicle position and dynamic states, as described herein. The vehicle position states include geographically defined x- and y-states (e.g., latitude and longitude), and an angular heading. The vehicle dynamic states include yaw, lateral acceleration and longitudinal acceleration states.

Various components, subsystems and systems may experience different rates of deterioration and aging over the service life of a vehicle, and may benefit from being managed and controlled in a way that imparts less stress under certain conditions to extend their service life and/or maintain an acceptable vehicle performance level.

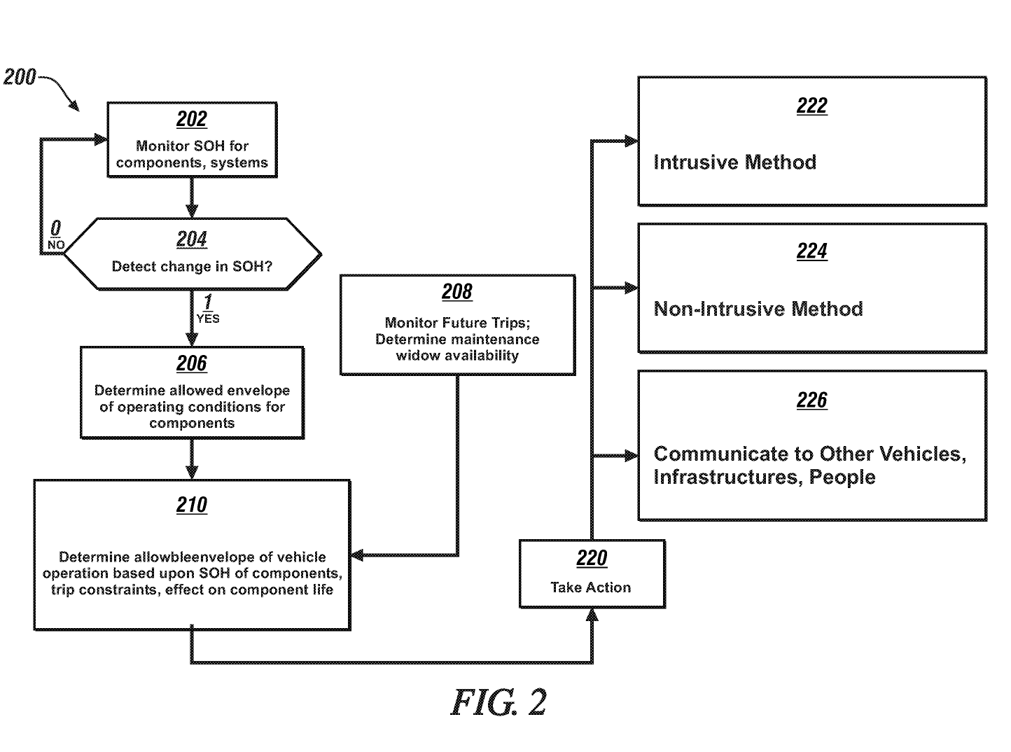

FIG. 2 is employed to describe a routine 200, executed as control routines and related calibrations, to control an embodiment of the vehicle 10 described with reference to FIG. 1. The process includes dynamically determining a working envelope of components and systems based on their respective states of health and generating an adaptable control and management scheme that facilitates component/system life and acceptable vehicle performance during a trip when prognosis of one or more of the systems or components indicates deterioration or a fault in its operation. Overall, the routine 200 includes monitoring states of health (SOHs) of a plurality of components that are disposed to effect a vehicle function during a trip. The components can be independent elements or elements employed in a system or subsystem that is disposed to achieve a vehicle function. The components are operatively controllable to effect a vehicle function, or are otherwise associated with a vehicle function in a manner that allows them to be monitored. The components can include devices, actuators, sensors, wiring harnesses, etc. Vehicle functions can include vehicle propulsion, vehicle braking, steering, navigation, etc. A trip can be defined as a single event that involves transporting an operator from a point of origin to a destination.

The routine 200 initiates upon detecting a change in status of the SOH of one of the components related to one of the vehicle functions, which is nominally called a subject component. A change in status of the SOH can include a change in prognostics from a GREEN status to either a YELLOW status or a RED status. Alternatively, or in addition, the SOH may have a numeric value, wherein change in status of the SOH can include a numeric difference that is greater than a preset magnitude. An allowable window of operation for the subject component can be determined based upon the change in status, and an allowable window of operation for one or related component(s) can also be determined. Related component(s) include those components that interact with or otherwise provide performance to achieve the vehicle function. Operating constraints related to the vehicle function can be determined based upon the allowable window of operation for the subject component and the allowable window of operation for the related component(s). Operation of the vehicle is controlled subject to the operating constraints related to the vehicle function to achieve completion of the present trip. Operating constraints can be associated with time, route type, route conditions, length of trip, traffic, weather conditions, complexity of trip including a quantity of stops, etc.

FIG. 2 schematically shows an information flow diagram associated with an embodiment of the routine 200, which can be advantageously implemented in a controller of an embodiment of the vehicle 10 that is described with reference to FIG. 1. The routine 200 can be executed as one or a plurality of control routines by the VHM controller 120, employing information stored therein or available from other devices either on-vehicle or off-vehicle. Table 1 is provided as a key wherein the numerically labeled blocks and the corresponding functions are set forth as follows, corresponding to the routine 200. The teachings may be described herein in terms of functional and/or logical block components and/or various processing steps. It should be realized that such block components may be composed of hardware, software, and/or firmware components that have been configured to perform the specified functions.

TABLE 1

| BLOCK | BLOCK CONTENTS |
|---|---|
| 202 | Monitor SOH for components, systems |
| 204 | Detect change in SOH? |
| 206 | Determine allowed envelope of operating |
| | conditions for components |
| 208 | Monitor future trips, determine maintenance |
| | window availability |
| 210 | Determine allowed envelope of vehicle |
| | operation based upon SOH of components, |
| | trip constraints, effect on component life |
| 220 | Take action |
| 222 | Intrusive action |
| 224 | Advisory action |
| 226 | Communication |

Execution of the routine 200 for controlling vehicle operation in view of a change in SOH of one or more components, subsystems, or systems includes as follows, wherein the steps may be executed in a suitable order, and are not limited to the order described with reference to FIG. 2.

The routine 200 includes regular, periodic and ongoing monitoring of SOH for the components, subsystems, and systems of the vehicle, including but not limited to those associated with the autonomic vehicle control system 20 (202) to detect a change in status (204)(0). Such monitoring can be executed in the VHM controller 120. A change in status of the SOH can include a change in prognostics from a GREEN status to either a YELLOW status or a RED status, or a change in numeric value of the SOH that is greater than a threshold. When a change in status of SOH of one of the components, subsystems or systems of the vehicle 10 is detected (204)(1), the routine 200 determines allowed envelopes of operating conditions for related components, subsystems or systems (206). The component, subsystem or system that experiences a change in status of its SOH is referred to herein as a “subject component”, and another component, subsystem or system that interacts with or mitigates effects of a change in status of the subject component is referred to herein as a “related component”.

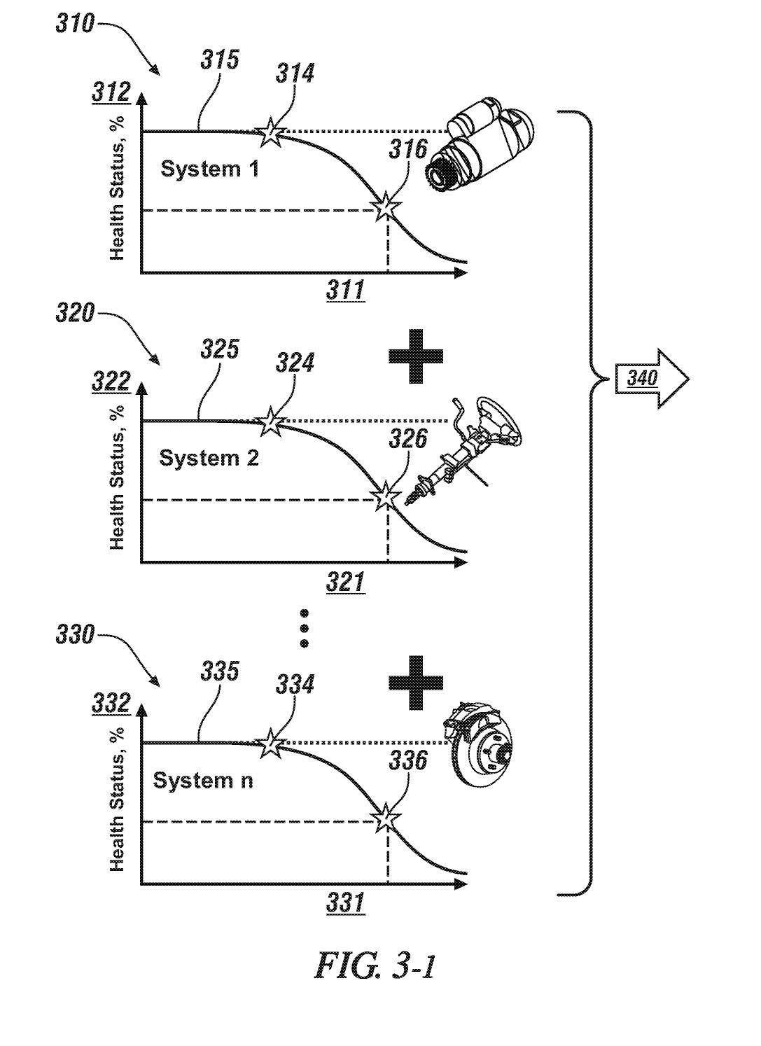

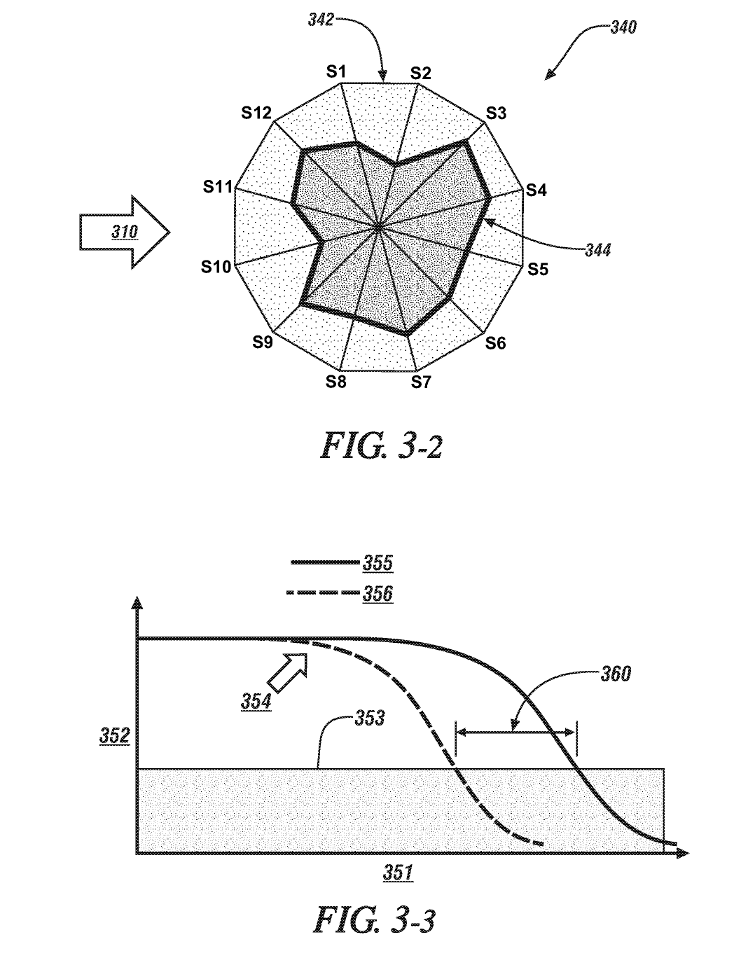

FIG. 3-1 graphically depicts SOHs associated with a plurality of components, subsystems or systems. This includes a first graph 310, which indicates a magnitude of component SOH (%) 312 on the vertical axis in relation to usage (311) on the horizontal axis, wherein usage can be either time or distance. Line 315 indicates the SOH for a first component, and includes a first point 314 at which the SOH begins to deteriorate, and a second point 316 at which the SOH has achieved a threshold level of reduction requiring action.

This also includes a second graph 320, which indicates a magnitude of component SOH (%) 322 on the vertical axis in relation to usage (321) on the horizontal axis, wherein usage can be either time or distance. Line 325 indicates the SOH for a second component, and includes a first point 324 at which the SOH for the second component begins to deteriorate, and a second point 326 at which the SOH for the second component has achieved a threshold level of SOH reduction requiring action.

This also includes a third graph 330, which indicates a magnitude of component SOH (%) 332 on the vertical axis in relation to usage (331) on the horizontal axis, wherein usage can be either time or distance. Line 335 indicates the SOH for an nth component, wherein n can be a numeral indicating a component count, and includes a first point 334 at which the SOH for the nth component begins to deteriorate, and a second point 336 at which the SOH for the nth component has achieved a threshold level of SOH reduction requiring action.

The results from FIG. 3-1 are employed to generate FIG. 3-2. FIG. 3-2 is a spider graph 340 that indicates states of health for a plurality of vehicle components, subsystems or systems. As shown, the SOHs for the components are indicated by elements S1, S2 . . . S12, wherein the outer periphery 342 of the spider graph 340 indicates an SOH of 100% and the origin point indicates an SOH of 0%. The outer periphery 342 indicates an operating envelope for the vehicle components, subsystems or systems when they are at SOHs=100%, and the periphery 344 indicates an operating envelope for the vehicle components, subsystems or systems when they are at SOHs that are less than 100%, indicating a need for managed action.

FIG. 3-3 graphically shows a magnitude of composite vehicle SOH (%) 352 on the vertical axis in relation to usage 351 on the horizontal axis, wherein usage can be either time or distance. Line 355 indicates a first composite SOH for the vehicle 10 under a managed condition employing an embodiment of the routine 200 described herein, and line 356 indicates a second composite SOH for the vehicle 10 under an unmanaged condition. Arrow 354 indicates a point at which a SOH of one of the vehicle components, subsystems or systems is less than 100%. Line 353 indicates an SOH level at which vehicle performance requires intervention, such as service or maintenance. As indicated by differential line 360, a time-between-service can be extended when employing the embodiment of the routine 200 described herein.

The routine 200 also monitors operator inputs indicating planned future trips, such as may be available from an appointment log that is included in the VHM controller 120 to determine a window of availability for vehicle maintenance (210).

The routine 200 determines an allowable envelope of vehicle operation based upon the SOHs of components, taking into account trip constraints, effects on component service life, and other factors (210), and takes action to implement control of the vehicle operation within the allowable envelope (220). The action(s) includes one or more of intrusive actions (222), non-intrusive actions (224) and extra-vehicle communications (226).

The intrusive actions (222) include managing, controlling and restricting operations of the components, subsystems and systems of the vehicle 10 based upon the allowable envelope, to enable completion of the present trip. This action includes controlling operation of the vehicle subject to the operating constraints related to the vehicle function. The operating constraints include an allowable window of operation for the subject component, which includes determining a limitation to the subject component to enable completion of the trip, wherein the limitation includes either an operating constraint for the subject component, or a performance constraint for the subject component that is associated with the vehicle function. Operating constraints include constraints on inputs that can be in the form of a signal or other command input, a force input, a temperature input, etc. Performance constraints include constraints on outputs, which can include vehicle acceleration, fuel economy, cornering force, etc. The operating constraints also include an allowable window of operation for each of the related components to enable completion of the trip, which includes determining a limitation to the related component to compensate for the limitation to the subject component. The limitation to the related component includes either an operating constraint for the related component or a performance constraint for the related component associated with the vehicle function.

The non-intrusive actions (224) include advising the vehicle operator regarding route selection, e.g., to avoid or undertake a specific route to minimize vehicle operation that may result in an interrupt in vehicle operation during the trip.

The extra-vehicle communications (226) include communicating to vehicle maintenance and service facilities for scheduling a service event. The extra-vehicle communications can include undertaking V2V communications with proximal vehicles on the travel route to inform them of restricted vehicle operation, allowing the proximal vehicles to proceed with caution when in proximity to the vehicle 10 during the present trip.

The process and methodologies described herein may be advantageously implemented at the vehicle assembly plant and employed throughout the vehicle life to extend the life of the vehicle. The process permits managing component stresses collectively, which may result in extending vehicle life.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for controlling a vehicle, the method comprising:
monitoring states of health (SOHs) of a plurality of components that are disposed to effect a vehicle function during a trip, wherein the plurality of components includes a subject component and a related component;
upon detecting a change in status of the SOH of the subject component:
determining an allowable window of operation for the subject component,
determining an allowable window of operation for the related component, and
determining operating constraints related to the vehicle function based upon the allowable window of operation for the subject component and the allowable window of operation for the related component; and
controlling operation of the vehicle subject to the operating constraints related to the vehicle function.

2. The method of claim 1, wherein determining an allowable window of operation for the subject component comprises determining a limitation to the subject component to enable completion of the trip.

3. The method of claim 2, wherein determining a limitation to the subject component to enable completion of the trip comprises determining an operating constraint for the subject component.

4. The method of claim 2, wherein determining a limitation to the subject component to enable completion of the trip comprises determining a performance constraint for the subject component associated with the vehicle function.

5. The method of claim 2, wherein determining an allowable window of operation for the related component comprises determining a limitation to the related component to compensate for the limitation to the subject component.

6. The method of claim 5, wherein determining a limitation to the related component to enable completion of the trip comprises determining an operating constraint for the related component.

7. The method of claim 6, wherein determining a limitation to the related component to enable completion of the trip comprises determining a performance constraint for the related component associated with the vehicle function.

8. The method of claim 1, further comprising determining the operating constraints for the vehicle function to effect completion of the trip.

9. The method of claim 1, further comprising advising an operator to avoid a route or to take another route.

10. The method of claim 1, wherein the vehicle is configured to effect vehicle-to-vehicle communications, the method further comprising: communicating to other vehicles that the vehicle is being controlled subject to the operating constraints related to the vehicle function.

11. A vehicle, comprising:
a plurality of components that are disposed to effect a vehicle function, wherein the plurality of components includes a subject component and a related component;
a controller in communication with the plurality of components, the controller including an instruction set, the instruction set executable to:
monitor states of health (SOHs) of the plurality of components including the subject component and the related component; and
upon detecting a change in status of the SOH of the subject component:
determine an allowable window of operation for the subject component,
determine an allowable window of operation for the related component, and
determine operating constraints related to the vehicle function based upon the allowable window of operation for the subject component and the allowable window of operation for the related component; and
control operation of the vehicle subject to the operating constraints related to the vehicle function.

12. The vehicle of claim 11, wherein the instruction set executable to determine an allowable window of operation for the subject component comprises the instruction set executable to determine a limitation to the subject component to enable completion of the trip.

13. The vehicle of claim 12, wherein the instruction set executable to determine a limitation to the subject component to enable completion of the trip comprises the instruction set executable to determine an operating constraint for the subject component.

14. The vehicle of claim 12, wherein the instruction set executable to determine a limitation to the subject component to enable completion of the trip comprises the instruction set executable to determine a performance constraint for the subject component associated with the vehicle function.

15. The vehicle of claim 12, wherein the instruction set executable to determine an allowable window of operation for the related component comprises the instruction set executable to determine a limitation to the related component to compensate for the limitation to the subject component.

16. The vehicle of claim 15, wherein the instruction set executable to determine a limitation to the related component to enable completion of the trip comprises the instruction set executable to determine an operating constraint for the related component.

17. The vehicle of claim 16, wherein the instruction set executable to determine a limitation to the related component to enable completion of the trip comprises the instruction set executable to determine a performance constraint for the related component associated with the vehicle function.

18. The vehicle of claim 11, further comprising the instruction set executable to determine the operating constraints for the vehicle function to effect completion of the trip.

19. The vehicle of claim 11, further comprising the instruction set executable to advise an operator to avoid a route or to take another route.

20. The vehicle of claim 11, wherein the vehicle is configured to effect vehicle-to-vehicle communications, and wherein the instruction set is executable to communicate to other vehicles that the vehicle is being controlled subject to the operating constraints related to the vehicle function.
